(19) United States
(12) Patent Application Publication
(10) Pub. No.: US 2004/0041039 A1
(43) Pub. Date: Mar. 4, 2004

(54) Common-ramp-injector

(76) Inventor: Karl Hofmann, Villingendorf (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/250,774

(22) PCT Filed: Oct. 25, 2002
(86) PCT No.: PCT/DE02/04016

(30) Foreign Application Priority Data
Nov. 9, 2001 (DE) 101-55-271.8

(51) Int. Cl. B05B 1/30; F02M 51/00

(52) U.S. Cl. 239/585.1

(57) ABSTRACT

The invention relates to an injector with high-pressure injection of fuel in self-igniting internal combustion engines, having a hollow injector body (1), which on one end includes a valve seat (2) and at least one injection opening (3). Furthermore, the injector of the invention includes a valve needle (4), which is disposed in an extension of a valve piston (5) in the injector body (1), so that in the closed state it closes the at least one injection opening (3), and at least one spring, which keeps the injector closed in the pressureless state by pressing the valve needle (4) into the valve seat (2). The injector further includes at least two magnet devices (37, 38), which serve to open and close the injector directly.

### BACKGROUND OF THE INVENTION

The common rail injection system serves to inject fuel into direct-injection internal combustion engines. In this reservoir injection system, the generation of pressure and the injection are decoupled from one another in terms of both time and place. A separate high-pressure pump generates the injection pressure in a central high-pressure fuel reservoir. The onset of injection and the injection quantity are determined by the instant and duration of triggering of injectors that for instance are actuated electrically and that communicate with the high-pressure fuel reservoir via fuel lines.

### PRIOR ART

German Patent Disclosure DE 196 50 865 A1 relates to a magnet valve for actuating a common rail injector. In FIG. 1 of this published, nonexamined patent disclosure, one such injector is shown. The injector communicates directly with a high-pressure fuel reservoir (common rail), which is constantly supplied with fuel that is at high pressure by a high-pressure feed pump. Via the magnet valve-controlled injector, the high-pressure fuel is delivered to the combustion chamber of the engine.

An injection by means of an injector in accordance with FIG. 1 of DE 196 50 865 A1 proceeds as follows: The opening and closure of the valve needle is controlled by the magnet valve. In the currentless state of the electrical magnet valve, an outlet throttle, by way of which the valve control chamber communicates with the fuel return, is closed by the valve member. Via an inlet throttle, the high pressure that is also present in the high-pressure fuel reservoir can then build up very rapidly in the valve control chamber. Together with a restoring spring, the pressure in the valve control chamber generates a closing force on the valve needle that is greater than the forces, resulting from the applied high pressure, that act on the other side on the valve needle in the opening direction. If the valve control chamber is opened toward the relief side by opening of the magnet valve, then the pressure in the small volume of the valve control chamber drops quite rapidly, since the valve control chamber is decoupled from the high-pressure side via the outlet throttle. As a consequence, the force acting on the valve needle in the opening direction and resulting from the high fuel pressure present at the valve needle predominates, so that the valve needle is moved upward and the injection openings are opened for injection. This indirect triggering of the valve needle via a hydraulic fuel booster system is employed because the forces required for fast opening of the valve needle cannot be generated directly by the magnet valve. The so-called control quantity needed then in addition to the injected fuel quantity reaches the fuel return via the throttle of the valve control chamber.

The injection quantity, in this common rail injection system used in the prior art, is determined by the triggering of the magnet valve, the adaptation of the inlet throttle to the outlet throttle, and the geometries of the valve piston and of the valve needle. The system becomes expensive because of the number of components required. Moreover, the injection quantity is subject to major variation because of the influence of the various parameters and tolerances.

### SUMMARY OF THE INVENTION

The embodiment according to the invention has the advantage that fewer components are needed in the common rail injector, and so costs are reduced. Moreover, the number of influential parameters on the injection quantity is reduced, and the injection quantity is controlled more precisely. These advantages are attained according to the invention by an injector with high-pressure injection of fuel in self-igniting internal combustion engines, and the injector includes a hollow injector body, which on one end includes a valve seat and at least one injection opening. Furthermore, the injector of the invention includes a valve needle, which is disposed in an extension of a valve piston in the injector body, so that in the closed state it closes the at least one injection opening, and at least one spring, which keeps the injector closed in the pressureless state by pressing the valve needle into the valve seat. The injector further includes at least two magnet devices, which serve to open and close the injector directly.

The expense for at least two magnet devices for direct triggering is markedly less than for indirect triggering of the valve needle via a hydraulic fuel booster system with an outlet throttle and an inlet throttle. For the direct triggering of the valve needle, forces are required that cannot be brought to bear solely by a magnet device, for the given dimensions of the injector. The injector of the invention therefore includes at least two magnet devices, which together are capable of bringing adequately strong forces to bear to open the valve needle.

### DRAWING

The present invention will be described in further detail below in conjunction with the drawing.

Shown are:

FIG. 1, a schematic illustration of an injector of the invention, with two magnet devices;

FIG. 2, a first embodiment of a valve needle tip of the invention;

FIG. 3, a graph showing the magnetic force as a function of the air gap between the electromagnet and the magnet armature;

FIG. 4, a second embodiment of a valve needle tip of the invention, with a throttle gap; and

FIG. 5, a third and fourth embodiment of a valve needle tip of the invention, also with a throttle gap.

### EMBODIMENT VARIANTS

FIG. 1 shows an injector according to the invention, with two magnet devices 37, 38. The injector comprises a hollow injector body 1, which on one end has a valve seat 2 and a plurality of injection openings 3. A valve needle 4 is disposed in an extension of a valve piston 5 in the injector body 1. The valve needle 4 closes the injection openings 3 tightly, in the closed state of the injector, against the combustion chamber (not shown). In this state, accordingly no injection of fuel into the combustion chamber of the engine takes place.

The left half of the injector shown is a variant with two springs 6, 7, while the right half shows a variant with one spring 8. The springs 7 and 8 are compression springs, which keep the injector closed in the pressureless state. They can also serve to assure the closing operation of the opened injector at the end of an injection. The springs 6, 7, 8 are located in a spring chamber 9 contained in the injector body 1. The inner spring 7 (when there are two springs) and the spring 8 (when there is one spring) rest on one end on a wall of the spring chamber 10. On its other end, they strike a disk 11, which is connected to the valve piston 5. When the injector is open, the valve piston 5, including the disk 11, is displaced in the opening direction 12 into the spring chamber 9, so that the spring 7, 8 becomes compressed and thus exerts a force in the closing direction 13 on the disk 11 and the valve piston 5.

In the variant with two springs 6, 7, the outer spring 6 likewise with one end strikes the wall of the spring chamber 10, where it is secured. With its other end, the spring 6 is connected to an annular disk 14 that is braced on the injector body 1. The outer spring 6 is prestressed to a defined force. The underside of the annular disk 14 is located at a spacing 15 from the top side of the disk 11. If upon opening of the injector in the opening direction 12 the valve needle 4 along with the valve piston 5 and the disk 11 is moved by the spacing 15, then the annular disk 14 rests on the disk 11. Upon still farther opening of the injector than the spacing 15, the disk 11 and the annular disk 14 are displaced jointly in the opening direction 12 in the spring chamber 9, so that both springs 6, 7 are simultaneously compressed and exert the force on the valve piston 5 in the closing direction 13.

In the preferred embodiment of the present invention, shown in FIG. 1, a high-pressure line 21 extends centrally in the longitudinal direction in the injector; it carries the fuel at high pressure, which is flowing into the injector from a high-pressure fuel reservoir (common rail) (not shown), through the injector to a fuel reserve chamber 22 of the injector. The fuel at high pressure passes through an inlet 23 into the high-pressure line 21. The high-pressure line discharges into the spring chamber 9 (through the wall 10) and continues on the other side of the spring chamber 9 through the disk 11 and the valve piston 5. In the region of the fuel reserve chamber 22, the valve piston 5 has a plurality of openings 24, through which the fuel reaches the fuel reserve chamber 22. From there, the fuel can flow along the valve needle 4 to the injection opening 3. A leak fuel line 27 serves to carry away leak fuel quantity.

In this preferred embodiment of the present invention, two magnet devices 37, 38 are used for directly opening and closing the injector; each has one magnet armature 16, 17 and one electromagnet 18, 19. The electromagnets 18, 19 are solidly connected to the injector body 1. The electromagnets 18, 19 are connected in parallel to a current source (not shown) via an electrical current terminal 25.

In the preferred embodiment of the present invention, shown in FIG. 1, the magnet armatures 16, 17 have different strokes (h₁ and h₂, respectively). The stroke (h₁, h₂) is understood to mean the distance that the magnet armature 16, 17 travels in the opening direction upon opening of the injector until it contacts the associated electromagnet 18, 19. FIG. 1 shows an injector of the invention in which the stroke h₁ of the first magnet armature 16 is shorter than the stroke h₂ of the second magnet armature 17. Preferably, the stroke h₁ of the first magnet armature is from 30 to 60 μm in length, and the stroke h₂ of the second magnet armature is from 150 to 250 μm in length.

In this preferred embodiment of the present invention, the second magnet armature 17 is disposed fixedly on the valve piston 5. Moreover, the first magnet armature 16 is disposed slidingly on the valve piston. With the injector closed, the first magnet armature 16 is located at an upper stop 20, which is created by means of an annular bulge of the valve piston 8. In this position of the first magnet armature 16, it is connected by nonpositive engagement to the valve piston 5, which has a diameter d₁. With the injector closed, the first magnet armature 16 is kept at the upper stop 20 by a restoring spring 39. When current is supplied to the electromagnets 18, 19, the magnetic force of the first electromagnet 18 acts on the first magnet armature 16 in the opening direction 12. At the same time, the magnetic force of the second electromagnet 19 acts on the second magnet armature 17 in the opening direction 12. As a result of the magnetic force of the two electromagnets 18, 19, the magnet armatures 16, 17 move the valve piston 5 along with the valve needle 4 in the opening direction 12, since the second magnet armature 17 is connected solidly, and the first magnet armature 16 is connected via the upper stop 20, to the valve piston 5. Consequently, the valve needle 4 lifts from the valve seat 2, and an injection of the fuel that is at high pressure takes place via the injection openings 3.

The first magnet armature 16, because of its shorter stroke h₁ during an opening event of the injector, is located on its associated first electromagnet 18 sooner than the second magnet armature 17. However, since the first magnet armature 16 is disposed slidingly on the valve piston 5, the second magnet armature 17, including the valve piston 5 fixedly connected to it, can move onward in the opening direction 12, until the second magnet armature 17 is also in contact with its associated second electromagnet 19. The first magnet armature 16 slides over a portion 26 of the valve piston 5 that has a smaller diameter than the valve piston 5 at the upper stop 20. Upon closure of the injector, the first magnet armature, with the aid of the restoring spring 39, reaches its outset position at the upper stop 20 again.

Because of the two different strokes h₁, h₂ of the magnet armatures 16, 17, the possibility of stroke adaptation is advantageously afforded; that is, for small injection quantities, the short stroke h₁ of the first magnet armature 16 can be executed. Thus the motion of the valve needle 4, which in the prior art has a ballistic course in the range under load, can be stably kept to a partial stroke (h₁). Consequently and advantageously, the variation in the injection quantity is reduced. The triggering of the partial stroke h₁ is possible via the current intensity and/or via how the spacing 15 is allocated. The partial stroke h₁ is set as precisely as is technically feasible, for instance by displacement of the electromagnet 18 with ensuing fixation by laser welding.

The injector shown in FIG. 1 is only one possible embodiment of the present invention. For instance, it is also conceivable for an injector of the invention to have two magnet devices 37, 38 which include two magnet armatures with equal-length strokes h that are mounted fixedly on the valve piston. When current is supplied to the two electromagnets, the valve needle is then moved by the stroke h in the opening direction by the magnetic force acting on the magnet armatures.

It is also for instance conceivable to supply current to the individual electromagnets via separate electrical terminals, making it possible to vary the magnetic force on the magnet armatures 16, 17 more freely.

In the embodiment of the present invention shown in FIG. 1, the diameter d₁ of the valve piston 5 (in the opening direction 12 relative to the upper stop 20) is equal to the diameter d₂ of the valve piston 5 (in the closing direction 13 relative to the second magnet armature 17). With the injector open, an equilibrium of forces prevails as a result of the high pressure in the opening direction and the closing direction (12, 13), since the effective surface areas on which the high pressure exerts a force in these two directions (12, 13) are the cross-sectional areas of the valve piston 5 having the diameters d₁ and d₂. Thus in the open state of the injector, the force of the high pressure in the closing direction 13 is exerted on an area

$${A}_{1}^{open} = {π ( \frac{{d}_{1}}{2} )}^{2}$$

and in the opening direction 12 on a surface area

$${A}_{2}^{open} = {π ( \frac{{d}_{2}}{2} )}^{2} .$$

If the diameters are equal, that is, if d₁=d₂, then (with the injector open),

A₁^{open}=A₂^{open}=A^{open},

and thus

F₁^{open}=p·A^{open}=F₂^{open},

in which p stands for the high pressure. For closing the injector after the electromagnets 18, 19 have been shut off, an additional force is accordingly needed, which is exerted by the springs 6, 7, 8.

In the closed state of the injector, the force from the high pressure on the valve piston 5 in the closing direction 13 is preferably greater than the force resulting from the high pressure in the opening direction 12. In the embodiment of the present invention shown in FIG. 1, this is assured with the provision that d₁=d₂, since the effective surface area on which the high pressure exerts a force in the opening direction 12 on the valve needle 4 and the valve piston 5 is reduced, with the injector closed, by the valve seat face 28 (A_{S}). The force in the closing direction 13 F₁^{closed} is accordingly greater than the force in the opening direction 12 F₂^{closed}. Then

$${A}_{1}^{closed} = {π ( \frac{{d}_{1}}{2} )}^{2}$$

$$and$$

$${A}_{2}^{closed} = {π ( \frac{{d}_{2}}{2} )}^{2} - {A}_{S}$$

where if d₁=d₂, it follows that

A₂^{closed}=A₁^{closed}−A_{S}

and thus

A₂^{closed}<A₁^{closed}, and F₂^{closed}<F₁^{closed}.

The closed injector accordingly remains closed solely because of the high pressure. The requisite force for opening the injector is determined by the difference in surface area, A₁^{closed}−A₂^{closed}, and the requisite force for compressing the springs 7, 8.

In a further embodiment (not shown) of the present invention, the diameter d₁<d₂, but the difference in surface areas A₂^{closed}−A₁^{open} is less than or at most equal to the valve seat area A_{S}. In this embodiment of the present invention as well, because of the condition A₂^{open}−A₁^{open}≦A_{S}, it is assured that with the injector closed, the force F₁^{closed} on the valve piston 5 and the valve needle 4 in the closing direction 13 is greater than or equal to the force F₂^{closed} resulting from the high pressure in the opening direction 12.

For closure of the open injector, in the variant where d₁<d₂, compared to the variant where d₁=d₂, an additional force ΔF

ΔF=F₂^{open}−F₁^{open}

must be brought to bear by the springs 6, 7, 8, and this additional force is proportional to the difference in surface area

ΔA=A₂^{open}−A₁^{open}.

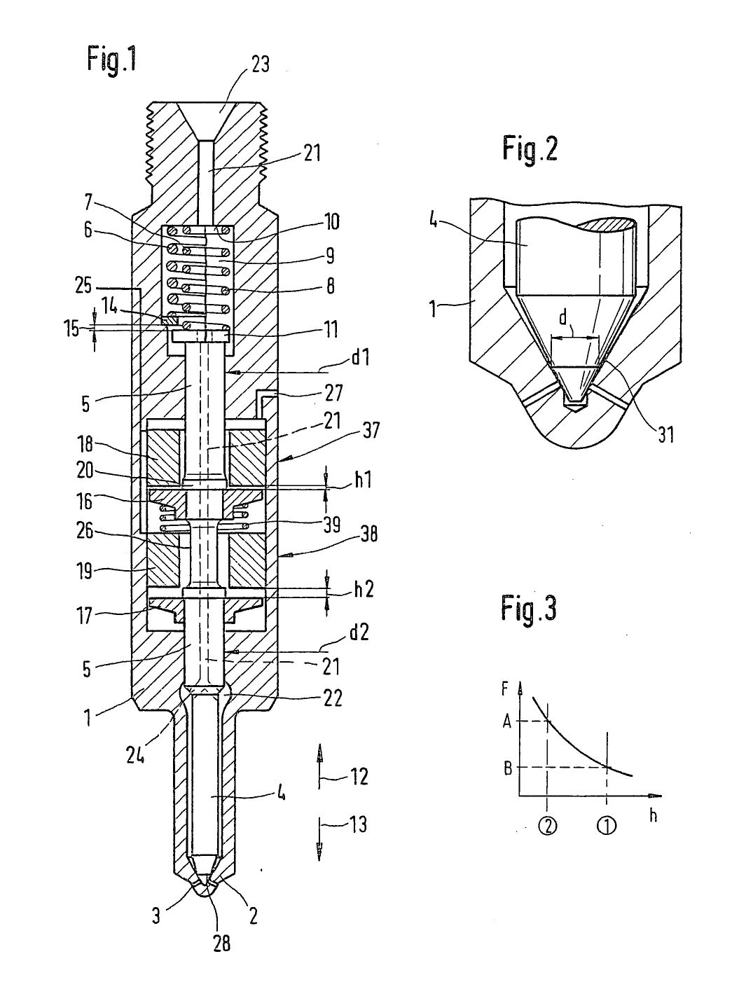

FIG. 2 shows an embodiment according to the invention of a valve needle. This is a valve needle 4 that has a form corresponding to the prior art but has a lesser diameter d in the region which, when the injector is closed, rests in the valve seat region 31 on the injector body 1. The lesser diameter d is required so that the injector can be opened with the maximum possible magnetic forces by the electromagnets 18, 19. In the present invention, the diameter d can for instance amount to 1.1 mm.

FIG. 3 shows a graph of the magnetic force as a function of the air gap between the electromagnet and the magnet armature. The magnetic force F is less, the larger the air gap h between the electromagnet 18, 19 and the magnet armature 16, 17. With the injector closed, the valve needle tip rests on the valve seat region 31, and the air gap between the second electromagnet 19 and the second magnet armature 17 assumes its maximum size (for instance, 0.25 mm). At this air gap size 1, the second magnet armature 17 is attracted by the second electromagnet 19 with the magnetic force B. At the partial stroke h₁, the air gap size is smaller (air gap size 2), and the second magnet armature 17 is attracted by the greater magnetic field force A. The magnetic force between the first magnet armature 17 and the first electromagnet 19 behaves in the same way.

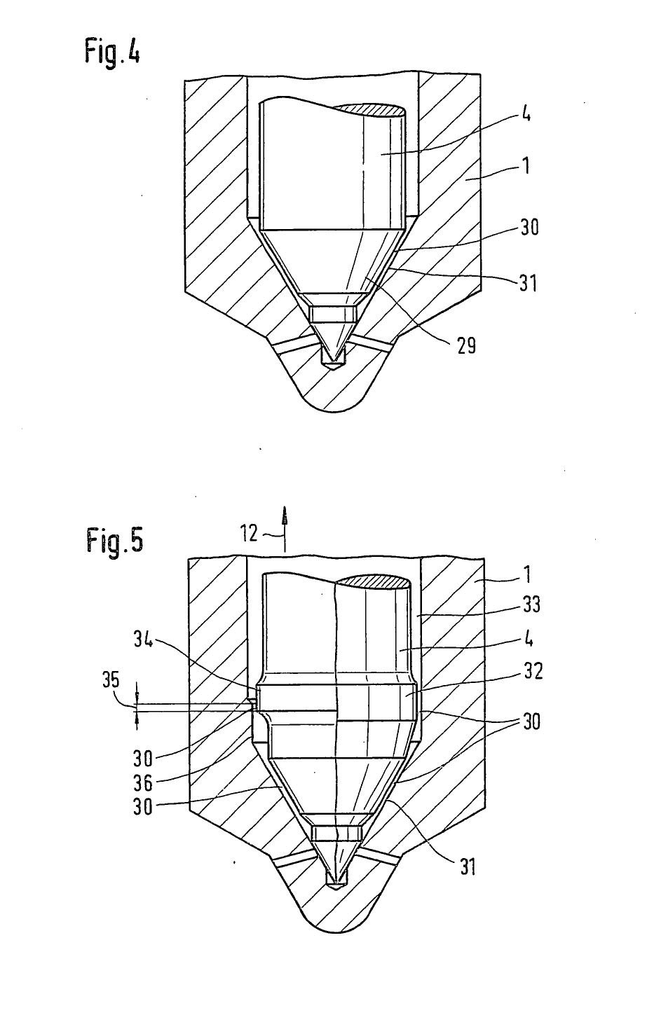

FIG. 4 shows an embodiment of the valve needle that is preferred according to the invention. To reduce the spring force required to close the open injector, particularly for the variant where d₁<d₂, the valve needle 4 and the valve needle tip 29 are shaped such that there is a throttle gap 30 between the valve needle 4 and the injector body 1. During the injection event, the pressure in the valve seat region 31 is reduced by means of the throttle gap 30, thus reinforcing the closing operation.

FIG. 5 shows two further preferred embodiments of a valve needle of the invention, one in the left half and the other in the right half of the drawing. In both embodiments shown, the valve needle 4 is again shaped such that with the injector open, between the valve needle 4 and the injector body 1 there is a throttle gap 30, which reduces the pressure in the valve seat region 31. In this embodiment, the throttling is reinforced still further compared to the embodiment shown in FIG. 4, since the throttle gap 30 extends not only within the conical valve seat region 31 but also along part of the cylindrical bore 33 in the valve body 1. In the embodiment shown in the right half of FIG. 5, this throttle gap 30 occurs along a portion of the cylindrical bore 33 of the valve body 1 through a partial region 32 of the valve needle 4 in which the valve needle 4 has a larger diameter. As a result, the interstice between the valve needle 4 and the valve body 1 is reduced in size, so that along this partial region 32, once again there is a throttle gap 30. This throttle gap 30 continues to exist along the partial region 32 regardless of the stroke of the valve needle 4.

Unlike the above, in the preferred embodiment of the injector of the invention shown in the left half of FIG. 5, the existence and length of the throttle gap along the partial region 34 is dependent on the position of the valve needle 4. The farther the valve needle 4 is displaced in the opening direction 12 relative to the valve body 1, the shorter is the overlap 35 between a region 36 of the bore 33 of smaller diameter and the partial region 34 of the valve needle 4 of larger diameter. Beyond a stroke of the valve needle 4 that is dependent on the width and disposition of the regions 34 and 36, there is no longer any overlap 35, and the spacing between the valve body 1 and the valve needle 1 becomes greater, so that throttling no longer occurs.

This preferred embodiment of the injector of the invention shown in the left half of FIG. 5 can advantageously be combined with the embodiment that has two springs. Upon opening of the injector, only the longer spring counteracts the magnetic forces. Beyond a certain prestroke of the longer spring (corresponding to spacing 15 in FIG. 1), both springs counteract the opening of the injector. However, the spring forces can be overcome, since even when the injector is partly open the high pressure acts in the seat region upon the valve needle 4, and the magnetic forces have already increased because of the slight spacing between the respective magnet armature 16, 17 and its electromagnet 18, 19. The injector opens completely, and the fuel injection takes place. For closure, the electromagnets are switched off. At first, both springs 6, 7 act on the valve piston 5. When the shorter spring 6 with the annular disk 14 reaches its stop in the injector body 1, and the longer spring is acting alone in the closing direction on the valve piston, the overlap 35 already becomes operative, and the hydraulic forces (pressure drop in the valve seat region 31) reinforce the complete closure of the injector.

1. An injector with high-pressure injection of fuel in self-igniting internal combustion engines, having
a) a hollow injector body (1), which on one end includes a valve seat (2) and at least one injection opening (3),
b) a valve needle (4), which is disposed in an extension of a valve piston (5) in the injector body (1), so that in the closed state it closes the at least one injection opening (3), and
c) at least one spring, which keeps the injector closed in the pressureless state by pressing the valve needle (4) into the valve seat (2),
characterized in that
the injector includes at least two magnet devices (37, 38), which serve to open and close the injector directly.

2. The injector of claim 1, characterized in that the at least two magnet devices (37, 38) each contain one magnet armature (16, 17) and one electromagnet (18, 19).

3. The injector of claim 2, characterized in that at least one magnet armature (17) is disposed fixedly on the valve piston (5).

4. The injector of claim 2, characterized in that at least one magnet armature (16) is disposed slidingly on the valve piston (5).

5. The injector of claim 2, characterized in that the magnet armatures (16, 17) have different strokes (h₁, h₂).

6. The injector of claim 1, characterized in that a high-pressure line (21) extends centrally in the injector in the longitudinal direction and carries the fuel at high pressure, which is flowing out of a high-pressure fuel reservoir into the injector, through the injector to a fuel supply chamber (22) of the injector.

7. The injector of claim 1, characterized in that with the injector closed, the force F₁^{closed} resulting from the high pressure on the valve piston (5) and on the valve needle (4) in the closing direction (13) is greater than the force F2^{closed} resulting from the high pressure in the opening direction (12).

8. The injector of claim 1, characterized in that with the injector closed, the force F₁^{closed} resulting from the high pressure on the valve piston (5) and on the valve needle (4) in the closing direction (13) is equal to the force F₂^{closed} resulting from the high pressure in the opening direction (12).

9. The injector of claim 1, characterized in that the injector includes two springs (6, 7), and one spring (6) surrounds the other spring (7), and one of the springs (6) is shorter and prestressed, so that only beyond a certain compression of the longer spring (7) does it exert a force on the valve piston (5) in the closing direction (13).

10. The injector of claim 1, characterized in that the valve needle (4), and in particular its valve needle tip (29), is shaped such that when the injector is partly open, a throttle gap (30) is located between the valve needle (4) and the injector body (1).

11. The injector of claim 10, characterized in that the existence, size and length of the throttle gap (30) depend on the position of the valve needle (4).

12. The injector of claim 9, characterized in that an overlap (35) becomes operative, as a result of which there is a throttle gap (30) between the valve needle (4) and the injector body (1) as soon as the shorter spring (6) has reached its stop, and the longer spring (7) alone acts in then closing direction (13) on the valve piston (5).
